(19) United States
(12) Patent Application Publication
(10) Pub. No.: US 2019/0301290 A1
(43) Pub. Date: Oct. 3, 2019

(54) COMPOSITE BLADE AND METHOD OF MANUFACTURING COMPOSITE BLADE

(71) Applicant: MITSUBISHI HEAVY INDUSTRIES, LTD., Tokyo (JP)

(72) Inventors: Masami Kamiya, Tokyo (JP); Ryoji OKABE, Tokyo (JP); Kentaro SHINDO, Tokyo (JP); Yoshinori NONAKA, Tokyo (JP)

(21) Appl. No.: 16/353,223

(22) Filed: Mar. 14, 2019

(30) Foreign Application Priority Data
Mar. 29, 2018 (JP) 2018-065882

(51) Int. Cl. F01D 5/28; B29C 70/20; F01D 5/14; F01D 5/30

(52) U.S. Cl. CPC F01D 5/282; B29C 70/202; B29L 2031/08; F01D 5/3007; F01D 5/147

(57) ABSTRACT

A composite blade formed by laying up composite material layers in which reinforced fibers are impregnated with resin in a blade thickness direction includes a blade root provided on a base side, an airfoil extending from a tip side of the blade root, a metal member provided on the blade root, and a fastener configured to fasten the blade root and the metal member. The blade root includes a main body portion, a curved portion that is curved outward in the blade thickness direction from the main body portion, and an extending portion that extends outward in the blade thickness direction from the curved portion. The metal member is fixed to the extending portion with the fastener.

### CROSS-REFERENCE TO RELATED APPLICATIONS

The present application claims priority to and incorporates by reference the entire contents of Japanese Patent Application No. 2018-065882 filed in Japan on Mar. 29, 2018.

### FIELD

The present invention relates to a composite blade and a method of manufacturing a composite blade.

### BACKGROUND

Conventionally, as a turbine blade for a gas turbine, a technology related to a composite blade formed by laying up composite material layers in which reinforced fiber is impregnated with resin has been known. For example, U.S. Pat. No. 8,100,662 discloses a composite blade including an airfoil and a blade root provided at a terminal of the airfoil. In the composite blade, a part of the composite material layer extending from the airfoil is formed at the blade root so as to be separated away from the blade root such that the blade root has a shape spreading outward from the airfoil, that is, a dovetail shape. Another composite material layer is additionally laid up at the position at which a part of the composite material layer is separated, and a region where no reinforced fiber is present (region where only resin is present) is reduced to suppress a reduction in strength of the blade root.

In the composite blade disclosed in U.S. Pat. No. 8,100,662, the additionally laid-up composite material layer is formed such that the toe of the composite material layer is located in a transition area where tensile stress and compressive stress caused in the composite blade are switched. As a result, stress caused in ply-drops where no reinforced fiber is present but only resin is present at the toe of the composite material layer is reduced. However, interlaminar shear stress on the composite material layers is not taken into consideration. Thus, there is a risk that ply-drops may be damaged in a region where interlaminar shear stress is high, and hence a composite blade capable of suppressing a reduction in strength of the blade root is sought after.

### SUMMARY

A composite blade according to an aspect of the present invention is a composite blade formed by laying up composite material layers in which reinforced fibers are impregnated with resin in a blade thickness direction. The composite blade includes a blade root provided on a base side; an airfoil extending from a tip side of the blade root; a metal member provided on the blade root; and a fastener configured to fasten the blade root and the metal member. The blade root includes a main body portion, a curved portion that is curved outward in the blade thickness direction from the main body portion, and an extending portion that extends outward in the blade thickness direction from the curved portion. The metal member contacts the main body portion, the curved portion, and the extending portion of the blade root and is fixed to the extending portion with the fastener.

### BRIEF DESCRIPTION OF THE DRAWINGS

FIG. 1 is a schematic view illustrating the outline of a composite blade according to a first embodiment.

FIG. 2 is a cross-sectional view of the composite blade as seen from a direction Y.

FIG. 3 a schematic view illustrating a configuration of a composite material layer.

FIG. 4 an explanatory diagram illustrating a procedure of a method of manufacturing a composite blade according to the first embodiment.

FIG. 5 a cross-sectional view of a composite blade according to a second embodiment as seen from the direction Y.

FIG. 6 is an explanatory diagram illustrating an assembly step in a method of manufacturing a composite blade according to the second embodiment.

FIG. 7 is a cross-sectional view of a composite blade according to a third embodiment as seen from the direction Y.

FIG. 8 is an explanatory diagram illustrating an additional lay-up step in a method of manufacturing a composite blade according to the third embodiment.

### DETAILED DESCRIPTION

A composite blade and a method of manufacturing a composite blade according to embodiments of the present invention are described in detail below with reference to the accompanying drawings. The present invention is not limited by the embodiments.

### First Embodiment

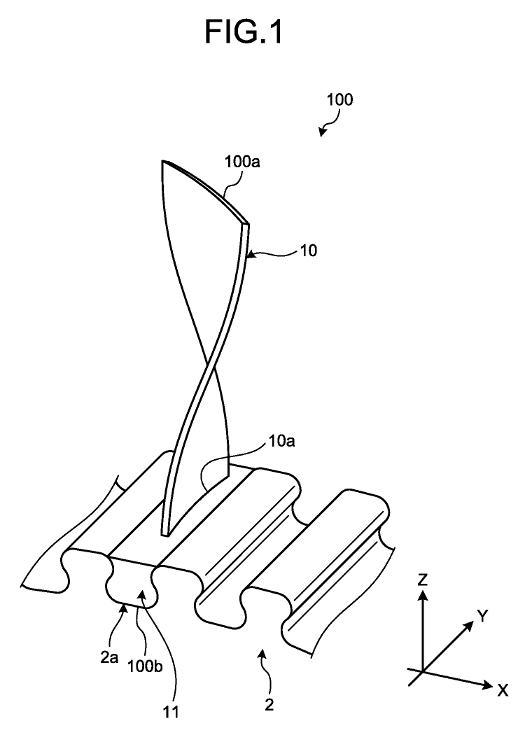

FIG. 1 is a schematic diagram illustrating the outline of a composite blade according to a first embodiment. A composite blade 100 according to the first embodiment is a turbine blade for a gas turbine. For example, a gas turbine using the composite blade 100 is used for an aircraft engine, but may be used for other purposes, such as a power generation gas turbine.

As illustrated in FIG. 1, the composite blade 100 extends from a tip 100a to a base 100b. The composite blade 100 is mounted to a turbine disk 2 on the base 100b side. The direction Z illustrated in FIG. 1 is a direction in which the composite blade 100 extends, that is, a direction along the tip 100a to the base 100b. The direction Z is a longitudinal direction of the composite blade 100. The direction Z corresponds to a radial direction. (radiation direction.) of the turbine disk 2. The direction. Y is a direction perpendicular to the direction Z, and is a direction along an axial direction of the turbine disk 2. The direction X is a direction perpendicular to the direction Y and the direction Z, and is a direction along the tangent to the circumference of the turbine disk 2.

The composite blade 100 includes an airfoil 10 and a blade root 11. The airfoil 10 is a blade for compressing gas flowing in the gas turbine when the turbine disk 2 rotates. The airfoil 10 extends from the tip 100a to the airfoil end 10a along the direction Z (longitudinal direction) of the composite blade 100 while being twisted. The blade root 11 is provided at the airfoil end 10a that is the terminal of the airfoil 10. In other words, the airfoil 10 extends along the direction Z from the blade root 11 on the tip 100a side.

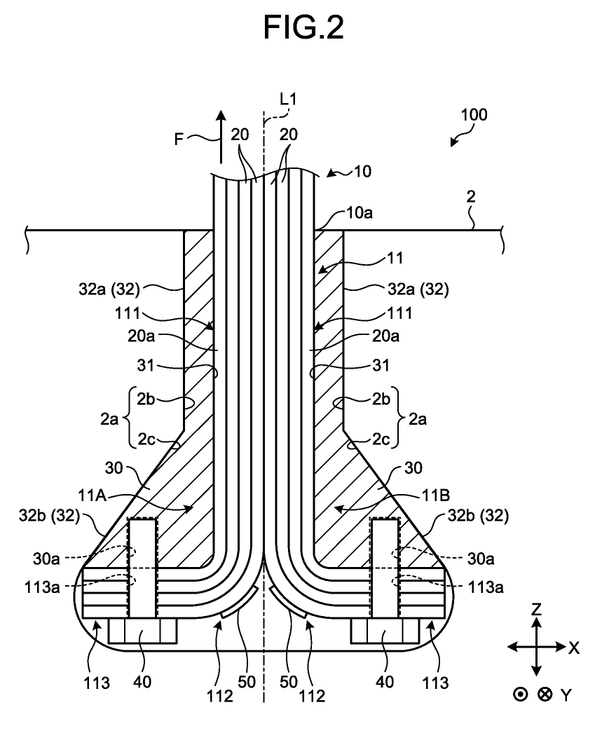

FIG. 2 is a cross-sectional view of the composite blade as seen from the direction Y. In the composite blade 100, the airfoil 10 and the blade root 11 are configured by lay-ups in which a plurality of composite material layers 20 are laid up along a blade thickness direction. The “blade thickness direction” is a blade thickness direction of the composite blade 100 at the airfoil end 10a, which is a root part of the airfoil 10 with respect to the blade root 11, and means the direction X (horizontal direction in FIG. 2). In the following description, the blade thickness direction is referred to as “direction X”. In the following description, the surface side of the composite blade 100 in the direction X is referred to as “outer side”.

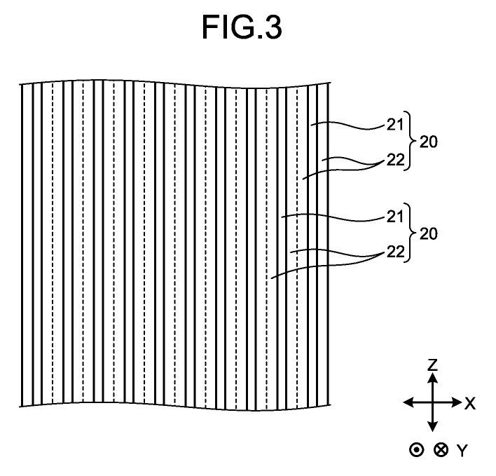

FIG. 3 is a schematic diagram illustrating a configuration of the composite material layer. The composite material layer 20 is a composite layer in which reinforced fiber 21 is impregnated with resin 22. In each composite material layer 20, as illustrated in FIG. 3, a plurality of reinforced fibers 21 are provided along the direction Z, and the resin 22 is filled around the reinforced fibers 21. The resins 22 of a composite material layer 20 and its adjacent (laid up) composite material layers 20 are bonded together, so that the resin 22 of one composite material layer 20 is integrated with the resin 22 of the other composite material layer 20. Thus, the composite material layer 20 is a layer in which the reinforced fiber 21 and the resin 22 around the reinforced fiber 21 are present. The composite material layer 20 may have another reinforced fiber extending in the direction different from the reinforced fiber 21 illustrated in FIG. 3. In this case, the other reinforced fiber may be woven with the reinforced fiber 21. In FIG. 2, four composite material layers 20 are schematically illustrated on each side of the centerline L1.

In the first embodiment, the reinforced fiber 21 is carbon fiber reinforced plastic (CFRP) using carbon fiber. The reinforced fiber 21 is not limited to carbon fiber, and may be other types of fiber, such as plastic fiber, glass fiber, or metal fiber. For example, the resin 22 is thermosetting resin or thermoplastic resin. As thermosetting resin, for example, epoxy resin can be used. As thermoplastic resin, for example, polyetheretherketone (PEEK), polyetherketoneketone (PEKK), or polyphenylenesulfide (PPS) can be used. The resin 22 is riot limited thereto, and another resin may be used.

As illustrated in FIG. 1, the turbine disk 2 has a plurality of grooves 2a formed along the circumferential direction with gaps therebetween. The composite blade 100 is mounted in the groove 2a at the blade root 11, and is thereby mounted and fixed to the turbine disk 2. As illustrated in FIG. 2, when the composite blade 100 is mounted to the groove 2a of the turbine disk 2, the composite blade 100 includes a metal member 30 interposed between the blade root 11 and the groove 2a, and bolts 40 (fasteners) configured to fasten the metal member 30 to the blade root 11. Configurations of the blade root 11 and the metal member 30 for mounting the composite blade 100 to the groove 2a are described in detail below with reference to FIG. 2.

### Blade Root 11

In the first embodiment, the blade root 11 shares the composite material layers 20 with the airfoil 10. Specifically, each composite material layer 20 constituting the blade root 11 extends continuously from the airfoil 10. In the first embodiment, as illustrated in FIG. 2, the blade root 11 is formed to have a shape substantially symmetric about the centerline L1 in the direction X. In the following description, a part of the blade root 11 disposed on the left side of the centerline L1 in the figures is appropriately referred to as “blade root 11A”, and a part of the blade root 11 disposed on the right side of the centerline L1 in the figures is referred to as “blade root 11B”.

The blade roots 11A and 11B have a main body portion 111, a curved portion 112, and a fixation portion (extending portion) 113. The main body portion 111 is continuous from the airfoil 10 and extends in the direction Z. The curved portion 112 extends from the base 100b side of the main body portion 111 and is curved outward in the direction X. In the first embodiment, the curved portion 112 is curved to have an angle of about 90° with respect to the main body portion 111. The fixation portion 113 is a part further extending outward in the direction X from the side of the curved portion 112 opposite to the main body portion 111. Thus, in the first embodiment, the blade roots 11A and 11B each have a substantially L shape in a cross section as seen from the direction Y. Thus, the blade root 11 obtained by integrating the blade roots 11A and 11B at the centerline L1 has a substantially L shape in a cross section as seen from the direction Y. In the fixation portions 113 of the blade roots 11A and 11B, fastening holes 113a through which the bolts 40 described later can be inserted are formed to pass through the composite material layers 20. A plurality of the fastening holes 113a are formed in the fixation portions 113 with gaps therebetween along the direction Y.

Metal Member 30

The metal member 30 is formed from a metal material. One metal member 30 is provided between the blade root 11A and the groove 2a and another metal member 30 between the blade root 11B and the groove 2a. An inner surface 31 of the metal member 30 has a shape conforming to the surface shape of the surface layer 20a of the blade root 11 (11A, 11B). Thus, the inner surface 31 of the metal member 30 has a substantially L shape in a cross section as seen from the direction Y similarly to the main body portion 111, the curved portion 112, and the fixation portion 113. An outer surface 32 of the metal member 30 has a shape conforming to the side surface shape of the groove 2a. In the first embodiment, as illustrated in FIG. 2, the groove 2a has a side surface 2b extending in the direction Z from the outer peripheral surface of the turbine disk 2, and an inclined surface 2c extending from the side surface 2b in a direction spreading outward in the direction X. Thus, the outer surface 32 of the metal member 30 has a side surface 32a formed so as to be contactable with the side surface 2b, and an inclined surface 32b extending in the direction spreading outward in the direction X so as to be contactable with the inclined surface 2c. In the metal members 30, a plurality of fastening holes 30a through which the bolts 40 (described later) can be fastened are formed at positions corresponding to the fastening holes 113a formed in the fixation portions 113 of the blade roots 11A and 11B.

Fixation of blade root 11 and metal member 30

The blade root 11 and the metal member 30 are fixed with the bolts 40 serving as fasteners. As described above, the bolts 40 are fastened to the fastening holes 113a formed in the fixation portions 113 of the blade roots 11A and 11B and the fastening holes 30a formed in the metal members 30, so that the blade roots 11A and 11B and the metal members 30 are fixed.

Damage Detection Sensor

In the first embodiment, damage detection sensors 50 are mounted to the respective curved portions 112 of the blade roots 11A and 11B. For example, the damage detection sensor 50 is a thin film ultrasonic testing (UT) sensor, which is a sensor capable of detecting the existence or non-existence of damage in each composite material layer 20 in the vicinity of the curved portion 112. The damage detection sensor 50 may be any type of sensor as long as the sensor is capable of detecting the existence or non-existence of damage in each composite material layer 20 and can be mounted to the curved portion 112 in the groove 2a.

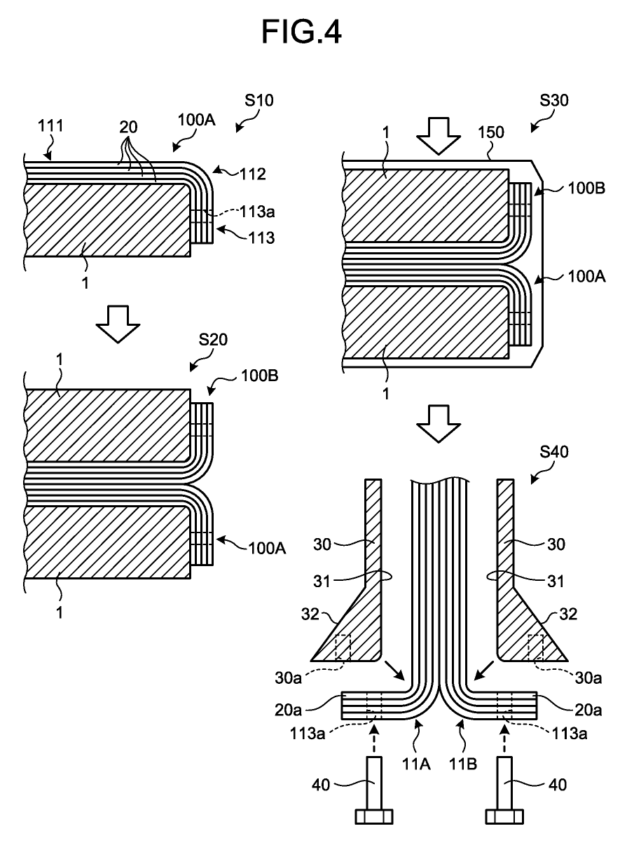

Next, a method of manufacturing a composite blade according to the first embodiment is described. FIG. 4 is an explanatory diagram illustrating a procedure of the method of manufacturing a composite blade according to the first embodiment. The method of manufacturing a composite blade according to the first embodiment includes a lay-up step S10, a mold setting step S20, a curing step S30, and an assembly step S40.

The lay-up step S10 is a step of laying up a plurality of composite material layers 20 to become the blade root 11. In the first embodiment, each composite material layer 20 continuously extends from the airfoil 10 to the blade root 11, and hence the lay-up step S10 can be regarded as a step of laying up a plurality of composite material layers 20 to become the airfoil 10 and the blade root 11. At the lay-up step S10, the composite material layer 20 is what is called “prepreg”, in which the resin 22 is uncured.

At the lay-up step S10, lay-ups 100A and 100B to become the airfoil 10 and the blade root 11 are separate formed. At the lay-up step S10, first, composite material layers 20 are laid up on a base 1 to form the lay-up 100A.

At this time, by forming the base 1 to have a substantially L-shaped surface shape in advance, the main body portion 111, the curved portion 112, and the fixation portion 113 can be formed at a part of the lay-up 100A to become the blade root 11. In each composite material layer 20, hole portions are formed at corresponding positions, so that a fastening hole 113a is formed in the fixation portion 113 in the laid-up state. The fastening hole 113a may be formed by processing the fixation portion 113 after the curing step S30 described later. Similarly, composite material layers 20 are laid up on the other base 1 to form the lay-up 100B (see step S20) including the blade root 11B. Next, as the mold setting step S20, the lay-up 100A and the lay-up 100B separately formed are aligned with each other. After the mold setting step S20 is finished, the curing step S30 is performed. The curing step S30 is a step of forming the composite blade 100 by curing the uncured resin 22 in the die-matched lay-up 100A and the lay-up 100B. At the curing step S30, for example, an uncured body of the composite blade 100 is covered with a bagging member 150 for vacuuming, and then is pressurized and heated in an autoclave oven to cure the resin 22. In this manner, cured bodies of the airfoil 10 and the blade root 11 are formed. The formation method at the curing step S30 is not limited thereto as long as the resin 22 is cured to form cured bodies of the airfoil 10 and the blade root 11.

Next, the assembly step S40 is performed. The assembly step S40 is a step of mounting the metal member 30 to the fixation portion 113. More specifically, as indicated by solid arrows in FIG. 4, the inner surface 31 of the metal member 30 is brought into contact with the surface layers 20a of the blade roots 11A and 11B molded at the curing step S30. Next, as indicated by broken arrows in FIG. 4, the bolts 40 are fastened to respective fastening holes 113a in the fixation portions 113 and respective fastening holes 30a in the metal members 30. In this manner, the blade roots 11A and 11B and the metal member 30 are fixed to manufacture the composite blade 100. The damage detection sensor 50 may be mounted to the curved portion 112 after the assembly step S40, or may be mounted to the curved portion 112 after the curing step S30. The composite blade 100 manufactured in this manner can be mounted to the turbine disk 2 by being inserted in the groove 2a of the turbine disk 2 along the direction Y that is the extending direction of the groove 2a.

As described above, in the composite blade 100 and the method of manufacturing a composite blade according to the first embodiment, the metal member 30 having the outer surface 32 inclined in the direction spreading outward in the direction X (blade thickness direction) is mounted to the surface layer 20a of the blade root 11, and hence it is unnecessary to form the blade root 11 to have a dovetail shape that is spread outward from the airfoil 10. In other words, the outer surface 32 of the metal member 30 satisfies the dovetail shape. In the state in which the composite blade 100 is mounted to the groove 2a of the turbine disk 2, the metal member 30 is interposed between the groove 2a and the surface layer 20a of the blade root 11, and the inclined surface 32b of the metal member 30 and the inclined surface 2c of the groove 2a contact with each other, and hence the composite blade 100 is prevented from falling out of the groove 2a. Thus, it is unnecessary to spread the blade root 11 outward in the direction X and additionally lay up a composite material layer 20 corresponding to the spread amount. In this manner, the blade root 11 can be formed without generating a ply-drop region (region where only the resin 22 is present) by additional lamination. Consequently, the composite blade 100 and the method of manufacturing a composite blade according to the first embodiment can provide a composite blade 100 capable of suppressing a reduction in strength of the blade root 11.

By fixing the metal member 30 to the fixation portions 113 of the blade root 11 with the bolts 40 (fasteners), the blade root 11 can be prevented from falling out of the groove 2a.

When centrifugal force F acts on the composite blade 100, the blade root 11 is pulled toward the tip 100a (upper side in FIG. 2), and hence the blade root 11 tends to be deformed in a direction in which the angle of the curved portion 112 with respect to the main body portion 111 becomes obtuse (tends to move in a direction in which curved portion 112 approaches the groove 2a). In the composite blade 100, the metal member 30 is interposed between the surface layer 20a of the blade root 11 and the groove 2a, and hence the deformation of the blade root 11 can be suppressed. In addition, the blade roots 11A and 11B each have a substantially L shape and are disposed so as to be opposed to each other across the centerline L1, and hence when the centrifugal force F acts on the composite blade 100, the blade roots 11A and 11B restrict the movement thereof. Also in this manner, the deformation of the blade root 11 is suppressed.

The metal member 30 is interposed between the surface layer 20a of the blade root 11 and the groove 2a, and hence, similarly to the case where a blade formed from a metal material is mounted to the groove 2a of the turbine disk 2, the composite blade 100 can be stably mounted to the turbine disk 2. In addition, even when the groove 2a and the metal member 30 slidingly move, the sliding surface is a metal surface, and hence this case can be dealt with similarly to a blade formed from a metal material. When centrifugal force F acts on the composite blade 100, the inclined surface 32b of the metal member 30 receives force from the inclined surface 2c of the groove 2a, and hence compressive force acts on the blade root 11 sandwiched by two metal members 30 from the two metal members 30. As a result, for example, as compared with the case where the metal member 30 does not have the inclined surface 32b, the surface pressure on the blade root. 11 from the metal member 30 becomes larger, and the blade root 11 and the two metal members 30 function as an integral member (dovetail portion) and receive the centrifugal force F. In this manner, component force of the centrifugal force F imposed on the metal member 30 can be increased while component force of the centrifugal force F imposed on the blade root 11 can be decreased. Consequently, the composite blade 100 can bear a larger centrifugal force F.

It is preferred that the composite material layers 20 forming the blade root 11 extend continuously from the airfoil 10.

With this configuration, the blade root 11 is formed without additionally laying up a composite material layer 20, and hence a reduction in strength of the blade root 11 can be suppressed by avoiding the generation of a ply-drop region by additional lamination.

The composite blade 100 further includes the damage detection sensor 50 provided at the curved portion 112 and configured to detect damage in the composite material layer 20.

With this configuration, when centrifugal force F acts on the composite blade 100, damage in the vicinity of the curved portion 112 of the blade root 11 where stress particularly apt to increase and damage easily occurs due to action of excessive tensile load or long-term operation can be detected in real time. Consequently, the lifetime of the composite blade 100 can be determined while the composite blade 100 is mounted to the turbine disk 2, and hence an investigation step can be omitted.

### Second Embodiment

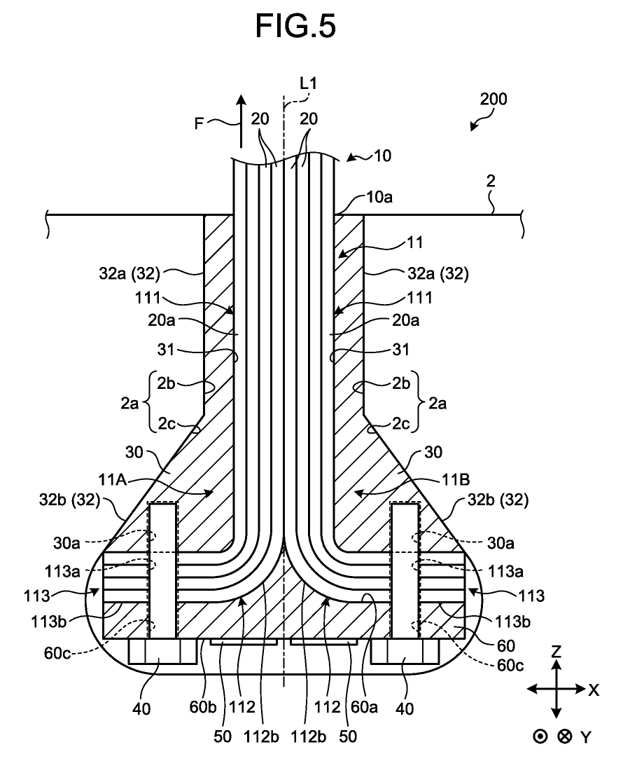

Next, a composite blade 200 according to a second embodiment is described. FIG. 5 is a cross-sectional view of the composite blade according to the second embodiment as seen from the direction Y. The composite blade 200 according to the second embodiment includes a second metal member 60 in addition to the configuration of the composite blade 100. The other configurations in the composite blade 200 are the same as those in the composite blade 100, and hence are denoted by the same reference symbols and descriptions thereof are omitted.

The second metal member 60 contacts with a surface of the blade root 11 different from the surface layer 20a contacting with the metal member 30. In the second embodiment, as illustrated in FIG. 5, the second metal member 60 has a top surface 60a having a shape conforming to a bottom surface 112b of the curved portion 112 on the base 100b side and a bottom surface 113b of the fixation portion 113 on the base 100b side. The top surface 60a of the second metal member 60 contacts with the bottom surfaces 112b and 113b. In the second metal member 60, a plurality of fastening holes 60c passing through the second metal member 60 from the top surface 60a to the bottom surface 60b are formed. The fastening holes 60c are formed at positions corresponding to the fastening holes 30a and the fastening holes 113a described above. In other words, in the state in which the second metal member 60 contacts with the bottom surfaces 112b and 113b, the fastening hole 30a, the fastening hole 113a, and the fastening hole 60c become one fastening hole continuously formed.

In the second embodiment, the above-mentioned damage detection sensor 50 is mounted to the bottom surface 60b of the second metal member 60. As illustrated in FIG. 5, the damage detection sensor 50 is provided below the curved portion 112. Specifically, the damage detection sensor 50 is provided at a position overlapping the curved portion 112 in the direction X.

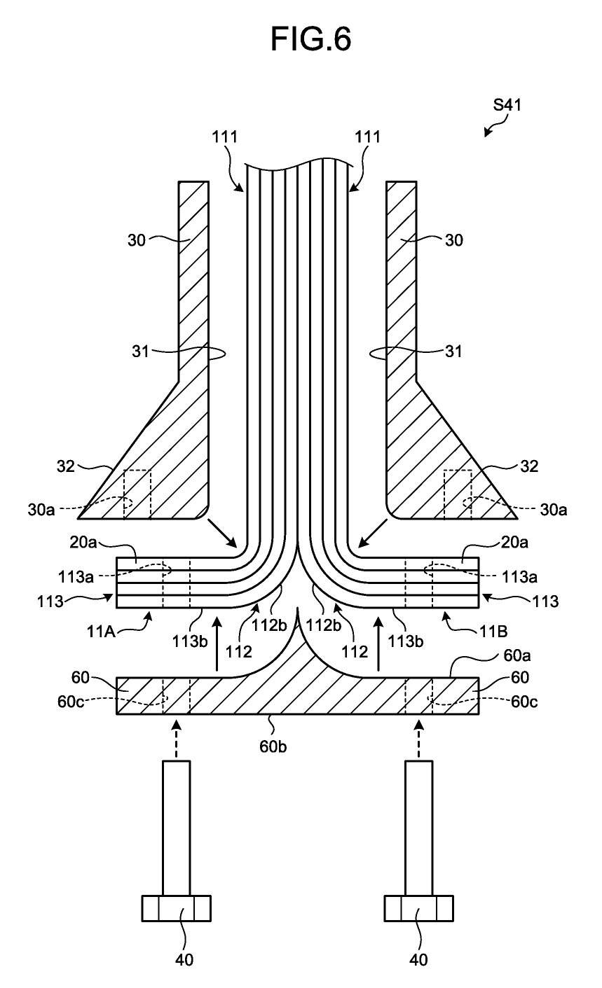

Next, a method of manufacturing a composite blade according to the second embodiment is described with reference to FIG. 6. FIG. 6 is an explanatory diagram illustrating an assembly step in the method of manufacturing a composite blade according to the second embodiment. The method of manufacturing a composite blade according to the second embodiment includes an assembly step S41 instead of the assembly step S40 in the method of manufacturing a composite blade according to the first embodiment. In the second embodiment, the lay-up step S10, the mold setting step S20, and the curing step S30 are the same as those illustrated in FIG. 4, and hence descriptions thereof are omitted.

In the second embodiment, at the assembly step S41, as indicated by solid arrows in FIG. 6, the inner surfaces 31 of the metal members 30 are brought into contact with the surface layers 20a of the blade roots 11A and 11B formed at the curing step S30, and the second metal member 60 is brought into contact with the bottom surfaces 112b and 113b. Next, as indicated by broken arrows in FIG. 6, bolts 40 are fastened to fastening holes 30a, fastening holes 113a, and fastening holes 60c. In this manner, the blade roots 11A and 11B are fixed to the metal member 30 and the second metal member 60 to manufacture the composite blade 200.

As described above, the composite blade 200 according to the second embodiment further includes the second metal member 60 mounted to the blade root 11 with the bolts 40 (fasteners) and contacting with a surface of the blade root 11 different from the surface contacting with the metal member 30.

With this configuration, the blade root 11 can be more satisfactorily prevented from being deformed when centrifugal force F acts on the composite blade 200.

The second metal member 60 contacts with the bottom surfaces 113b of the fixation portions 113 on the base 100b side, and is mounted to the fixation portions 113 with the bolts 40 together with the metal member 30.

With this configuration, the blade root 11 is sandwiched by the metal member 30 and the second metal member 60, and hence the blade root 11 can be more satisfactorily prevented from being deformed when centrifugal force F acts on the composite blade 200. The second metal member 60 is mounted to the fixation portion 113 by the bolts 40 together with the metal member 30, and hence the number of fastening holes 113a for the bolts 40 formed in the fixation portions 113 can be reduced to suppress a reduction in strength of the blade root 11.

The composite blade 200 further includes the damage detection sensor 50 provided on the second metal member 60 under the curved portion 112 and configured to detect damage in the composite material layer 20.

With this configuration, even when the second metal member 60 is provided, damage in the vicinity of the curved portion 112 of the blade root 11 where stress is particularly apt to increase can be detected in real time.

### Third Embodiment

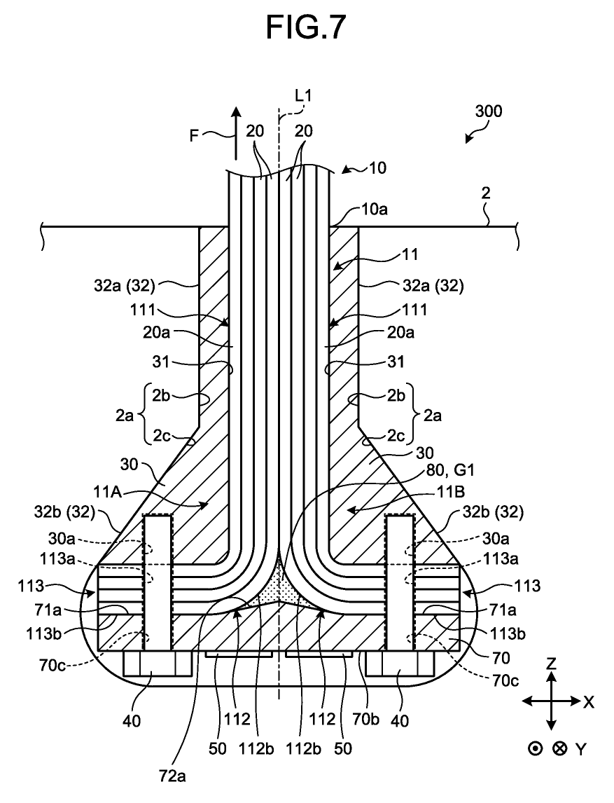

Next, a composite blade 300 according to the third embodiment is described. FIG. 7 is a cross-sectional view of the composite blade according to the third embodiment as seen from the direction Y. The composite blade 300 according to the third embodiment includes a second metal member 70 instead of the second metal member 60 in the composite blade 200 according to the second embodiment. The composite blade 300 includes an additional lay-up 80 in addition to the configuration of the composite blade 200 according to the second embodiment. The other configurations in the composite blade 300 are the same as those in the composite blade 200, and hence are denoted by the same reference symbols and descriptions thereof are omitted.

As illustrated in FIG. 7, the second metal member 70 has top surfaces 71a having a shape extending along the bottom surface 113b of the fixation portion 113 on the base 100b side. A top surface 72a extending between the top surfaces 71a has a shape that protrudes from the top surfaces 71a to be convex with an angle smaller than the bottom surface 112b of the curved portion 112 on the base 100b side. Thus, in the state in which the second metal member 70 is brought into contact with the bottom surface 113b of the fixation portion 113, a gap G1 extending along the direction Y is formed between the top surface 72a and the bottom surface 112b of the curved portion 112. In the second metal member 70, similarly to the second metal member 60, a plurality of fastening holes 70c passing through the second metal member 70 from the top surface 71a to the bottom surface 70b are formed.

The additional lay-up 80 is a lay-up formed by laying up a plurality of the composite material layers 20. The additional lay-up 80 is provided in a gap G1 formed between the top surface 72a of the second metal member 70 and the bottom surface 112b of the curved portion 112. In the second embodiment, in the additional lay-up 80, the reinforced fibers 21 extend along the direction Y perpendicular to the direction Z (longitudinal direction) and the direction X (blade thickness direction).

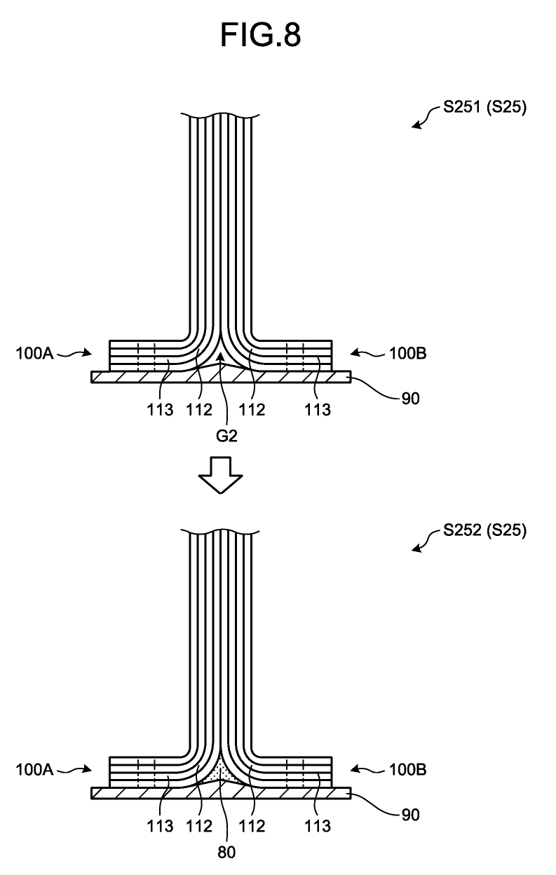

Next, a method of manufacturing a composite blade according to the third embodiment is described with reference to FIG. 8. FIG. 8 is an explanatory diagram illustrating an additional lay-up step in the method of manufacturing a composite blade according to the third embodiment. The method of manufacturing a composite blade according to the third embodiment further includes an additional lay-up step S25 in addition to the steps in the method of manufacturing a composite blade according to the second embodiment.

The additional lay-up step S25 is performed after the lay-up step S10 and the mold setting step S20 and before the curing step S30. The additional lay-up step S25 is a step of additionally laying up the above-mentioned additional lay-up 80 on the lay-up 100A and the lay-up 100B aligned at the mold setting step S20. More specifically, at the additional lay-up step S25, as indicated by the step S251 in FIG. 8, a plate-shaped member 90 is disposed on the lower side of the curved portions 112 and the fixation portions 113 of the aligned lay-up 100A and lay-up 100B. The plate-shaped member 90 has a shape conforming to the top surfaces 71a and 72a of the above-mentioned second metal member 70. Thus, in the state in which the plate-shaped member 90 is in contact with the fixation portion 113, a gap G2 having the same shape as the above-mentioned gap G1 is formed between the plate-shaped member 90 and the curved portion 112 along the direction Y. As indicated by the step S252 in FIG. 8, the additional lay-up 80 is laid up in the gap G2. At this time, the reinforced fibers 21 in the additional lay-up 80 are extended in a direction along the direction Y as described above. In this manner, by using the plate-shaped member 90 conforming to the surface shape of the second metal member 70, the shape of the additional lay-up 80 can be easily adjusted to the surface shape of the second metal member 70.

After that, the lay-ups 100A and 100B and the additional lay-up 80 are formed by the same method as the curing step S30 illustrated in FIG. 4, and the metal member 30 and the second metal member 70 are mounted by the same procedure as the assembly step S41 illustrated in FIG. 6. In this manner, the composite blade 300 is formed.

As described above, the composite blade 300 according to the third embodiment further includes the additional lay-up 80 formed by laying up the composite material layers 20 and provided between the second metal member 70 and the curved portion 112.

This configuration can reduce the size of the second metal member 70 to reduce the weight of the composite blade 300.

In the additional lay-up 80, the reinforced fiber 21 extends along the direction Y perpendicular to the direction Z (longitudinal direction) and the direction X (blade thickness direction).

With this configuration, the composite material layer 20 of the additional lay-up 80 can be filled between the curved portion 112 and the second metal member 70 without a gap.

In the first to third embodiments, the damage detection sensor 50 may be omitted. The damage detection sensor 50 may be provided near the fastening hole 113a formed in the fixation portion 113.

In the second embodiment, for example, the second metal member 60 may be mounted to a side surface of the blade root 11 in the direction Y. In this case, the second metal member 60 only needs to be fixed to any position on the blade root 11 by a fastener. Such a configuration can suppress the deformation of the blade root 11 by the second metal member 60.

A composite blade according to an aspect of the present invention is a composite blade formed by laying up composite material layers in which reinforced fibers are impregnated with resin in a blade thickness direction. The composite blade includes a blade root provided on a base side; an airfoil extending from a tip side of the blade root; a metal member provided on the blade root; and a fastener configured to fasten the blade root and the metal member. The blade root includes a main body portion, a curved portion that is curved outward in the blade thickness direction from the main body portion, and an extending portion that extends outward in the blade thickness direction from the curved portion. The metal member contacts the main body portion, the curved portion, and the extending portion of the blade root and is fixed to the extending portion with the fastener.

With this configuration, the metal member having the outer surface inclined in the direction spreading outward in the blade thickness direction is mounted to the surface layer of the blade root, and hence it is unnecessary to form the blade root to have a dovetail shape that is spread outward from the airfoil. In other words, the outer surface of the metal member satisfies the dovetail shape. Thus, it is unnecessary to spread the blade root outward in the blade thickness direction and additionally lay up a composite material layer corresponding to the spread amount. In this manner, the blade root can be formed without generating a ply-drop region by additional lamination.

Consequently, the present invention can provide a composite blade capable of suppressing a reduction in strength of the blade root.

Further, it is preferable that the metal member and the extending portion have fastening holes into which the fastener is inserted, and the metal member and the extending portion are fixed with the fastener inserted into the fastening holes.

Further, it is preferable that the composite material layer forming the blade root continuously extends from the airfoil.

With this configuration, the blade root is formed without additionally laying up a composite material layer, and hence a reduction in strength of the blade root can be suppressed by avoiding the generation of a ply-drop region by additional lamination.

Further, it is preferable that the metal member is fixed with the fastener together with a second metal member contacting a surface of the extending portion on the base side.

With this configuration, the blade root is sandwiched by the metal member and the second metal member, and hence the blade root can be more satisfactorily prevented from being deformed when centrifugal force acts on the composite blade. The second metal member is mounted to the extending portion with the fasteners together with the metal member, and hence the number of fastening holes for the fasteners formed in the extending portion can be reduced to suppress a reduction in strength of the blade root.

Further, it is preferable that an additional lay-up formed by laying up a plurality of the composite material layers and provided between the second metal member and the curved portion is further included.

With this configuration, the size of the second metal member can be reduced to reduce the weight of the composite blade.

Further, it is preferable that in the additional lay-up, reinforced fibers extend along a direction perpendicular to a longitudinal direction and the blade thickness direction.

With this configuration, the composite material layer of the additional lay-up can be filled between the curved portion and the second metal member without a gap.

Further, it is preferable that a sensor provided at the curved portion to detect damage in the composite material layer is further included.

With this configuration, when centrifugal force acts on the composite blade, damage in the vicinity of the curved portion of the blade root where stress is particularly apt to increase and damage easily occurs due to action of excessive tensile load or long-term operation can be detected in real time.

Further, it is preferable that a sensor provided on the second metal member below the curved portion to detect damage in the composite material layer is further included.

With this configuration, even when the second metal member is provided, damage in the vicinity of the curved portion of the blade root where stress is particularly apt to increase can be swiftly detected.

A method according to another aspect of the present invention is a method of manufacturing a composite blade formed by laying up composite material layers in which reinforced fibers are impregnated with resin in a blade thickness direction and including a blade root provided on a base side and an airfoil extending from a tip side of the blade root. The method includes a lay-up step of laying up a plurality of the composite material layers serving as the blade root; a curing step of forming the blade root; and an assembly step of fixing a metal member to the blade root. The blade root includes a main body portion, a curved portion that is curved outward in the blade thickness direction from the main body portion, and an extending portion that extends outward in the blade thickness direction from the curved portion. The assembly step includes mounting the metal member to the extending portion with a fastener with the metal member contacting the main body portion, the curved portion, and the extending portion of the blade root.

With this configuration, the metal member having the outer surface inclined in the direction spreading outward in the blade thickness direction is mounted to the surface layer of the blade root, and hence it is unnecessary to form the blade root to have a dovetail shape that is spread outward from the airfoil. In other words, the outer surface of the metal member satisfies the dovetail shape. Thus, it is unnecessary to spread the blade root outward in the blade thickness direction and additionally lay up a composite material layer corresponding to the spread amount. In this manner, the blade root can be formed without generating a ply-drop region by additional lamination. Consequently, the present invention can provide a method of manufacturing a composite blade capable of suppressing a reduction in strength of the blade root.

Further, it is preferable that the metal member and the extending portion have fastening holes into which the fastener is inserted, and the metal member and the extending portion are fixed with the fastener inserted in the fastening holes.

Further, it is preferable that the assembly step includes mounting the metal member and a second metal member to the extending portion with the fastener with the second metal member contacting a surface of the extending portion on the base side.

With this configuration, the blade root is sandwiched by the metal member and the second metal member, and hence the blade root can be more satisfactorily prevented from being deformed when centrifugal force acts on the composite blade. The second metal member is mounted to the extending portion with the fastener together with the metal member, and hence the number of fastening holes for the fastener formed in the extending portion can be reduced to suppress a reduction in strength of the blade root.

Further, it is preferable that after the lay-up step and before the curing step, an additional lay-up step of disposing a plate-shaped member conforming to a surface shape of the second metal member at a lower portion of the curved portion of the blade root and forming, on the plate-shaped member, an additional lay-up obtained by laying up a plurality of the composite material layers is further included.

With this configuration, the size of the second metal member can be reduced to reduce the weight of the composite blade. By using the plate-shaped member conforming to the surface shape of the second metal member, the shape of the additional lay-up can be easily adjusted to the surface shape of the second metal member.

While certain embodiments have been described, these embodiments are not intended to limit the scope of the inventions. The components in the embodiments include ones that a person skilled in the art can easily conceive of, ones that are substantially the same, or ones that fall within their equivalents. Furthermore, various omissions, substitutions, combinations, and changes may be made as appropriate to configurations of the components disclosed in the embodiments without departing from the spirit of the inventions.

1. A composite blade formed by laying up composite material layers in which reinforced fibers are impregnated with resin in a blade thickness direction, the composite blade comprising:
a blade root provided on a base side;
an airfoil extending from a tip side of the blade root;
a metal member provided on the blade root; and
a fastener configured to fasten the blade root and the metal member, wherein
the blade root includes a main body portion, a curved portion that is curved outward in the blade thickness direction from the main body portion, and an extending portion that extends outward in the blade thickness direction from the curved portion, and
the metal member contacts the main body portion, the curved portion, and the extending portion of the blade root and is fixed to the extending portion with the fastener.

2. The composite blade according to claim 1, wherein the metal member and the extending portion have fastening holes into which the fastener is inserted, and the metal member and the extending portion are fixed with the fastener inserted into the fastening holes.

3. The composite blade according to claim 1, wherein the composite material layer forming the blade root continuously extends from the airfoil.

4. The composite blade according to claim 3, wherein the metal member is fixed with the fastener together with a second metal member contacting a surface of the extending portion on the base side.

5. The composite blade according to claim 4, further comprising an additional lay-up formed by laying up a plurality of the composite material layers and provided between the second metal member and the curved portion.

6. The composite blade according to claim 5, wherein, in the additional lay-up, reinforced fibers extend along a direction perpendicular to a longitudinal direction and the blade thickness direction.

7. The composite blade according to claim 1, further comprising a sensor provided at the curved portion to detect damage in the composite material layer.

8. The composite blade according to claim 4, further comprising a sensor provided on the second metal member below the curved portion to detect damage in the composite material layer.

9. A method of manufacturing a composite blade formed by laying up composite material layers in which reinforced fibers are impregnated with resin in a blade thickness direction and including a blade root provided on a base side and an airfoil extending from a tip side of the blade root, the method comprising:
laying up a plurality of the composite material layers serving as the blade root;
forming the blade root; and
fixing a metal member to the blade root, wherein
the blade root includes a main body portion, a curved portion that is curved outward in the blade thickness direction from the main body portion, and an extending portion that extends outward in the blade thickness direction from the curved portion, and
fixing the metal member includes mounting the metal member to the extending portion with a fastener with the metal member contacting the main body portion, the curved portion, and the extending portion of the blade root.

10. The method of manufacturing a composite blade according to claim 9, wherein the metal member and the extending portion have fastening holes into which the fastener is inserted, and the metal member and the extending portion are fixed with the fastener inserted in the fastening holes.

11. The method of manufacturing a composite blade according to claim 9, wherein fixing the metal member includes mounting the metal member and a second metal member to the extending portion with the fastener with the second metal member contacting a surface of the extending portion on the base side.

12. The method of manufacturing a composite blade according to claim 11, further comprising, after laying up the composite material layers and before forming the blade root, disposing a plate-shaped member conforming to a surface shape of the second metal member at a lower portion of the curved portion of the blade root and forming, on the plate-shaped member, an additional lay-up obtained by laying up a plurality of the composite material layers.
